(19) United States
(12) Patent Application Publication
(10) Pub. No.: US 2011/0078518 A1
(43) Pub. Date: Mar. 31, 2011

(54) SYSTEMS AND METHODS FOR IMPROVING A FLOW OF DEFECT RESOLUTION

(76) Inventors: Richard Scott Foster, Greenville, SC (US); Robert Jay Ullius, Merritt Island, FL (US); Jack E. Adkins, Leland, NC (US)

(21) Appl. No.: 12/570,525

(22) Filed: Sep. 30, 2009

(51) Int. Cl. G06F 11/07; G06F 3/048

(52) U.S. Cl. 714/57; 714/E11.025

(57) ABSTRACT

A user interface embodied on one or more computer storage media having computer executable instructions for instructing a processor to display a history of a plurality of defects in a defect resolution process that includes a plurality of phases is provided. The user interface includes a display portion for illustrating a current phase of a defect from the plurality of phases, and a display portion for illustrating an amount of elapsed time that the defect has been in the current phase.

### RELATED APPLICATIONS

The field of the invention relates generally to systems and methods for improving a flow of defect resolution, and more particularly to systems and methods for presenting a visual representation of a backlog of defects at particular phases during a resolution of the defects.

The process of developing software applications involves designing and testing the software application. Corrective maintenance of, and improvements to the software application may continue after sending the software application to end users. A defect (e.g., a bug) is generally defined as a flaw in a software application that causes all or some portion of the software application to malfunction or to perform in some unexpected fashion. As the commercial software application marketplace demands ever more powerful and feature-rich software applications, and as the complexity of software applications increases, the number of defects increase. Although software application development is designed to prevent defects, software application developers are not perfect and have a limited capacity to deal with complexity, therefore mistakes leading to defects are inevitable.

In order to improve software application quality, software application manufacturers employ defect-tracking systems. Defect-tracking systems help software application manufacturers identify bugs that are in a software application while the software application is being developed or tested prior to release, or after the software application has been released to the end user. Software application developers, software application testers, end users, and other interested parties may report defects to a defect-tracking system by various means, such as telephone or email. The software application manufacturer collects reported software application defects and stores the details of the reported defects for analysis. However, while a software developer, through the use of a conventional bug-tracking system, follows through on some or all of the reported bugs, ensuring that bugs are rated and fixed to enhance the quality of the software application, there is currently no way for conventional bug-tracking systems to provide proper visual representation of a tracking process to, for example, analyze a flow of each defect/bug through an implementation process. Thus, utilizing a conventional defect-tracking system is problematic due to increased backlogs that may occur. That is, conventional defect-tracking systems do not provide proper visual representation of a tracking process and therefore are insufficient in analyzing a flow of each defect/bug through an implementation process. For example, reported defects/bugs may sit in different stages of the implementation process for long periods of time before a software developer addresses the defect/bug, and/or defects/bugs are resolved solely based on their severity level, which creates a backlog of defects/bugs which are not as severe.

### BRIEF DESCRIPTION OF THE INVENTION

In one aspect, some configurations of the present invention provide a user interface embodied on one or more storage media having computer executable instructions for instructing a processor to display a history of a plurality of defects in a defect resolution process that includes a plurality of phases. The user interface includes a display portion for illustrating a current phase of a defect from the plurality of phases, and a display portion for illustrating an amount of elapsed time that the defect has been in the current phase.

In another aspect, some configurations of the present invention provide a method for creating a user interface for use in displaying a history of a plurality of defects in a defect resolution process including a plurality of phases. The method includes receiving information indicating which phase in the plurality of phases each of the defects is currently in, receiving information indicating an elapsed time period each of the plurality of defects has been in the current phase, creating a user interface comprising the received information, and presenting the user interface on a display device.

In yet another aspect, some configurations of the present invention provide a system for creating a user interface for use in displaying a history of a plurality defects in a defect resolution process including a plurality of phases. The system includes a computing device, a memory area, a display device, and a processor. The processor is programmed to access information stored in the memory area indicating which phase in the plurality of phases each of the plurality defects is currently in, access information stored in the memory area indicating an elapsed period of time each of the plurality of defects has been in the current phase, create a user interface including the accessed information, and present the user interface on the display device.

### BRIEF DESCRIPTION OF THE DRAWINGS

FIG. 1 is a block diagram of an exemplary system for creating a user interface for use in displaying a history of a plurality defects in a defect resolution process.

FIG. 2 is a flowchart of a portion of an exemplary process performed by the system shown in FIG. 1.

FIGS. 3-3I and 4-4G are exemplary screen shots of a user interface for use in displaying a history of a plurality defects in a defect resolution process.

### DETAILED DESCRIPTION OF THE INVENTION

As used herein, an element or step recited in the singular and proceeded with the word “a,” “an,” or “one” (and especially, “at least one”) should be understood as not excluding plural said elements or steps, unless such exclusion is explicitly stated. Furthermore, references to “one embodiment” (or to “other embodiments”) of the present invention are not intended to be interpreted as excluding either the existence of additional embodiments that also incorporate the recited features or of excluding other features described in conjunction with the present invention. Moreover, unless explicitly stated to the contrary, embodiments “comprising” or “having” an element or a plurality of elements having a particular property may include additional such elements not having that property.

The foregoing description is directed to managing a flow of defect resolution in software. However, one of ordinary skill in the art guided by the teaching herein will appreciate that the methods and systems described herein are also applicable to other types of workflow management and manufacturing other than software.

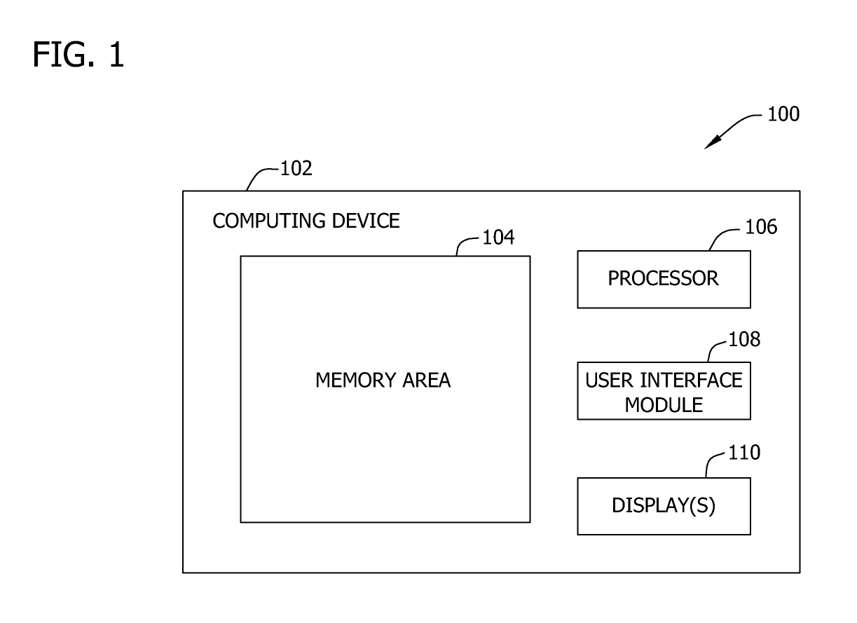

FIG. 1 is a block diagram of an exemplary system for creating a user interface for use in displaying a history of a plurality defects in a defect resolution process including a plurality of phases. System 100 includes a computing device 102, such as a desktop computing device, a laptop, an embedded device, a personal digital assistant, and/or other portable and non-portable computing devices capable of hosting and/or connecting to computing device 102.

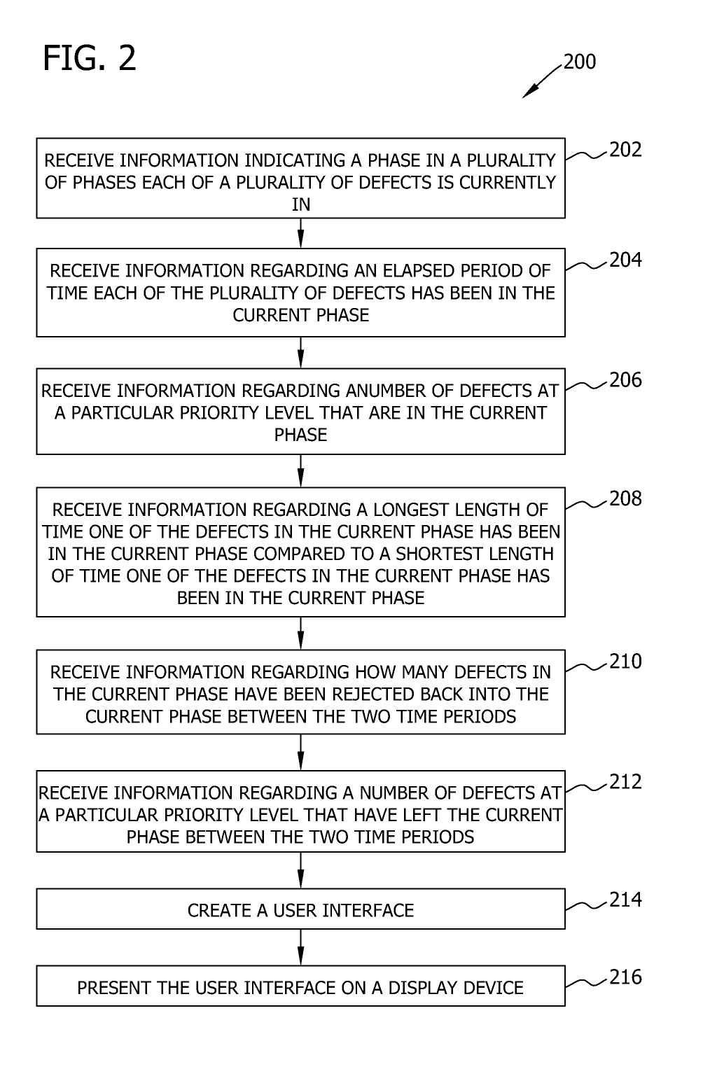

Computing device 102 includes a memory area 104 and at least one processor 106. Processor 106 is programmed to execute computer-executable instructions for implementing aspects of the disclosure. For example, in some embodiments, processor 106 is programmed to execute instructions such as those illustrated in the figures (e.g., FIG. 2). Although processor 106 is shown separate from the memory area 104 in FIG. 1, embodiments of the disclosure contemplate that memory area 104 may be onboard processor 106 such as in some embedded systems.

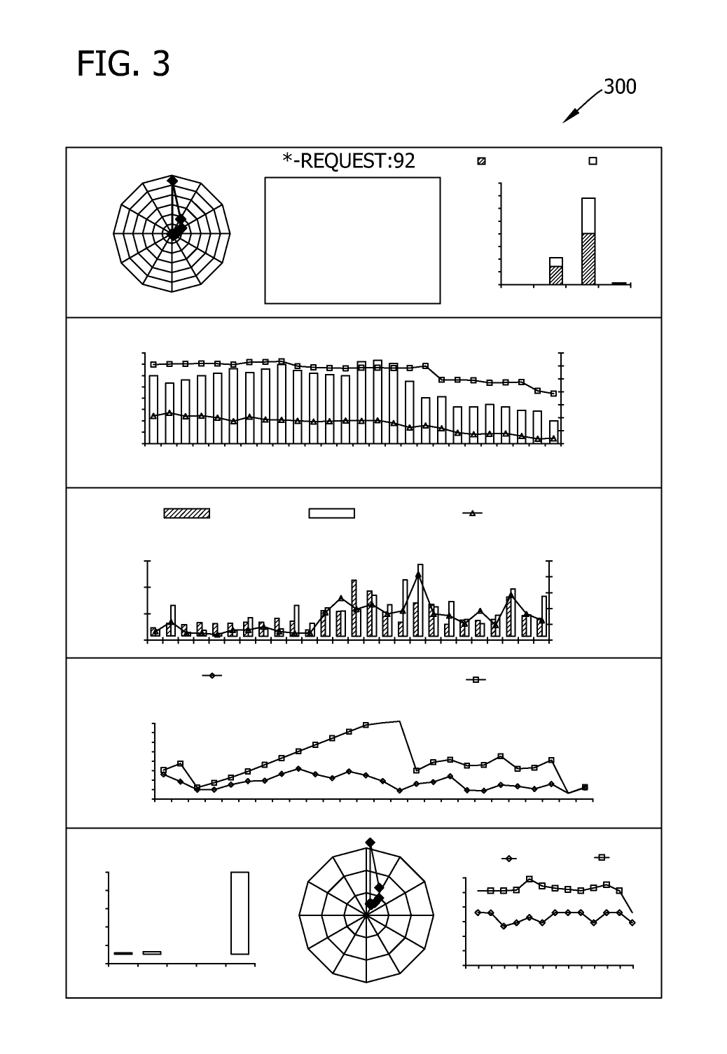

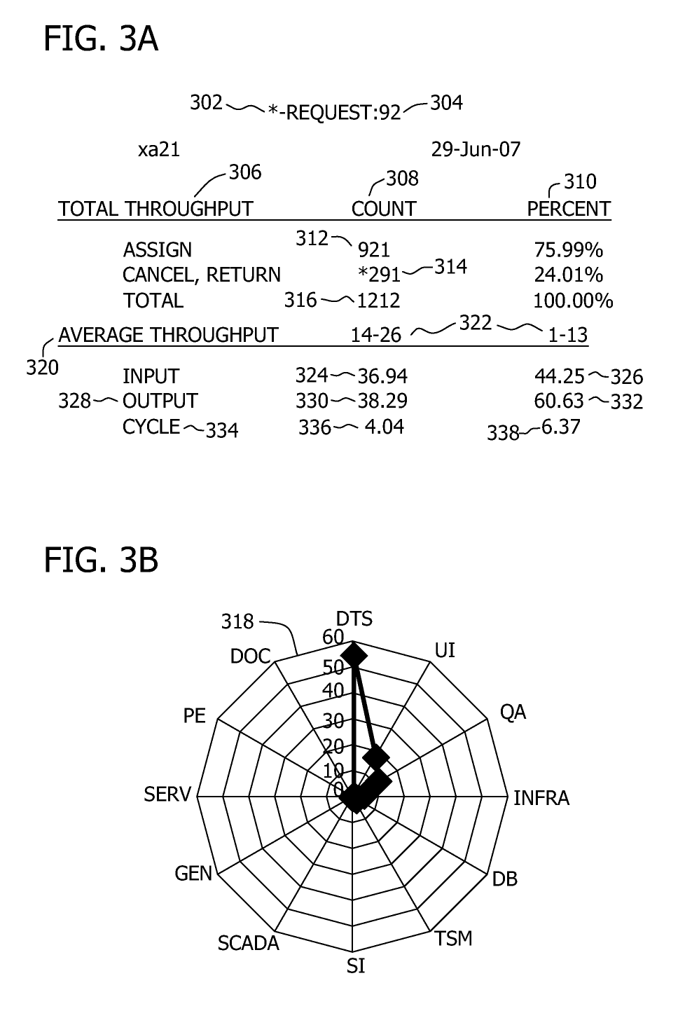

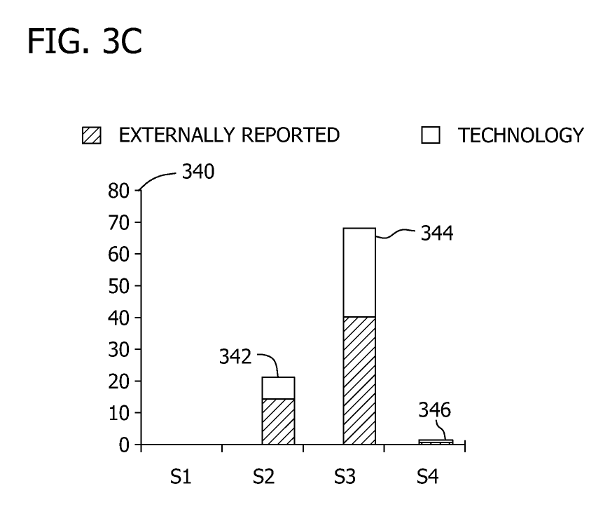

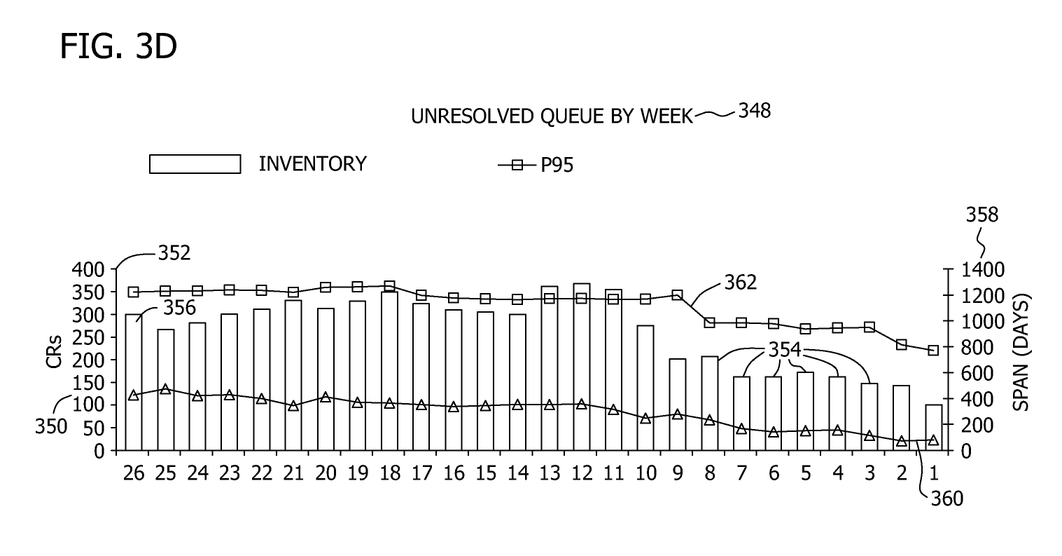

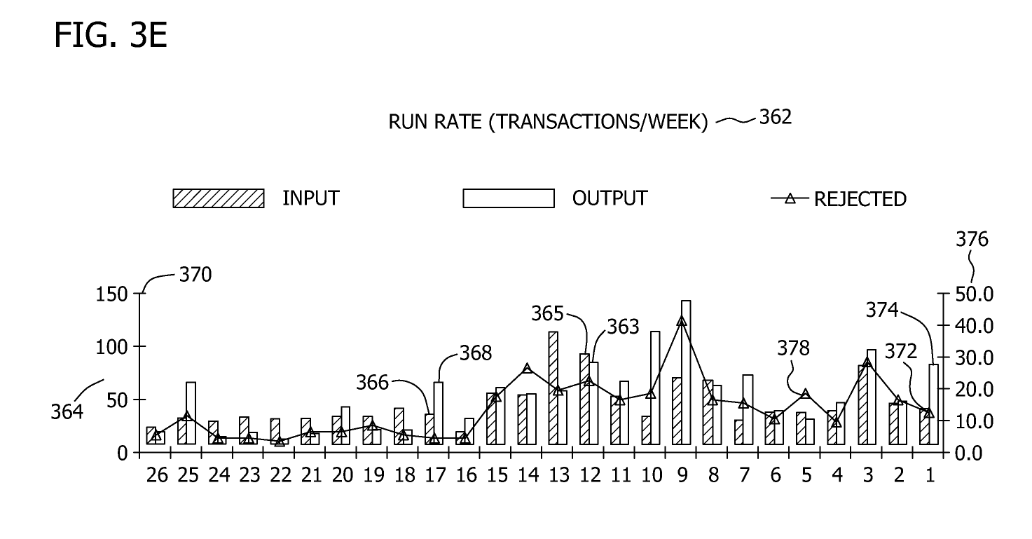

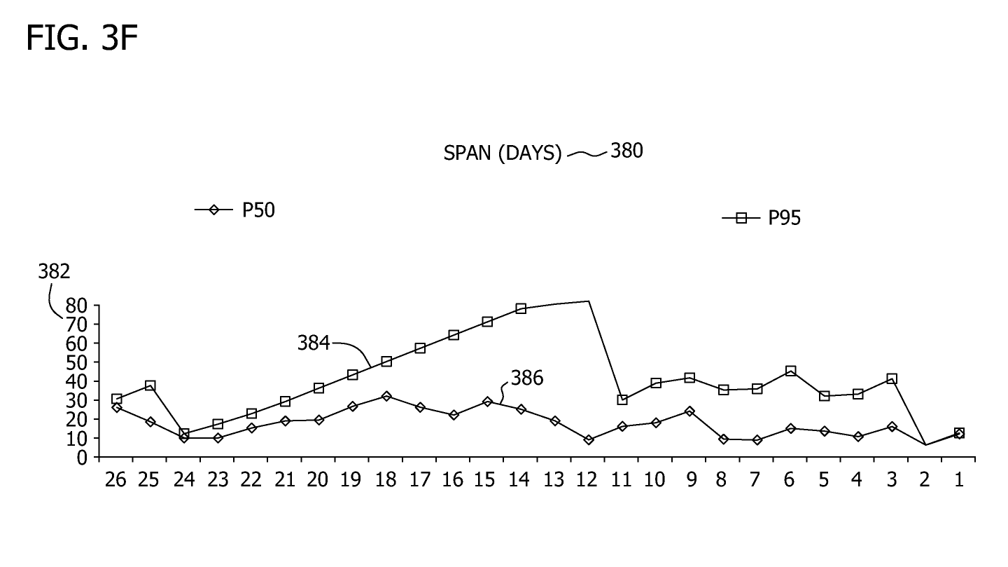

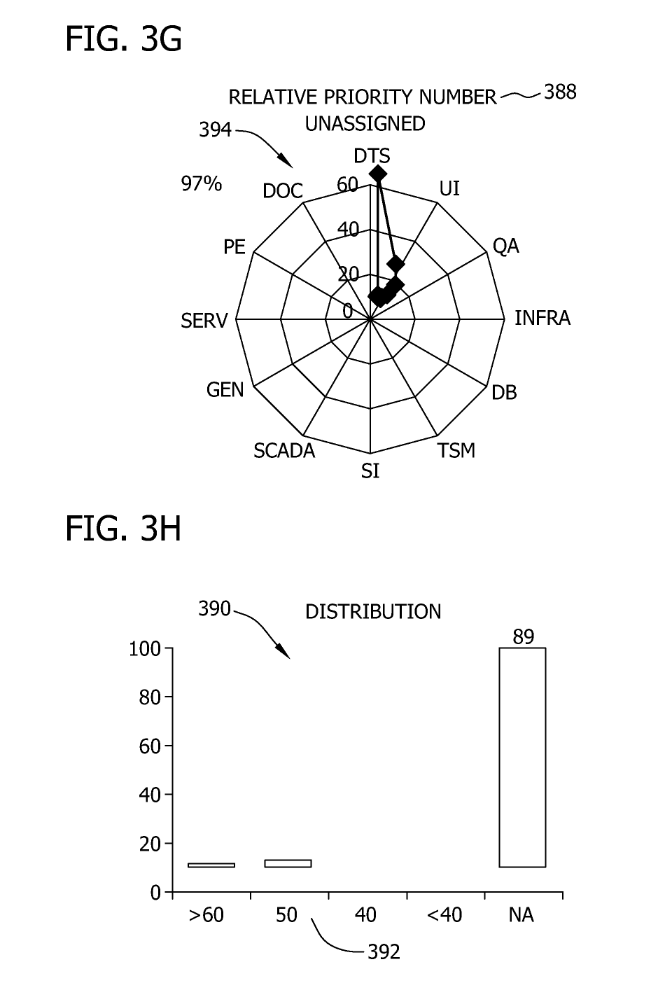

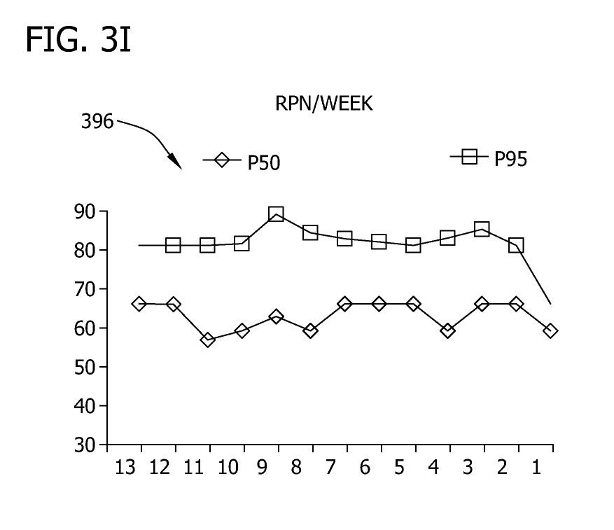

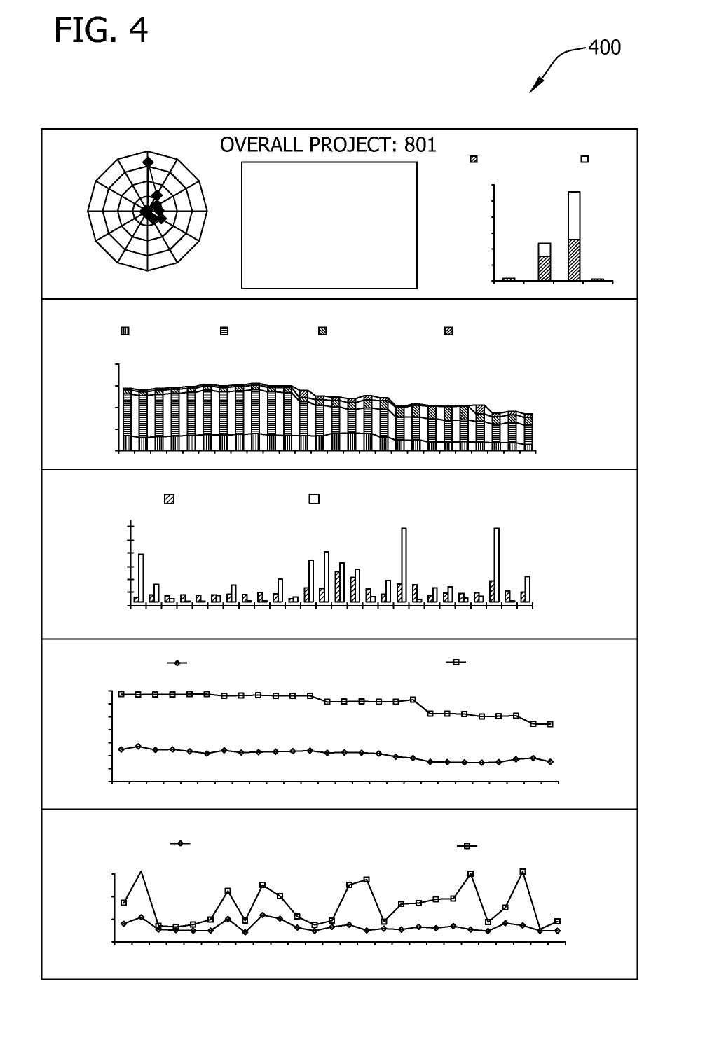

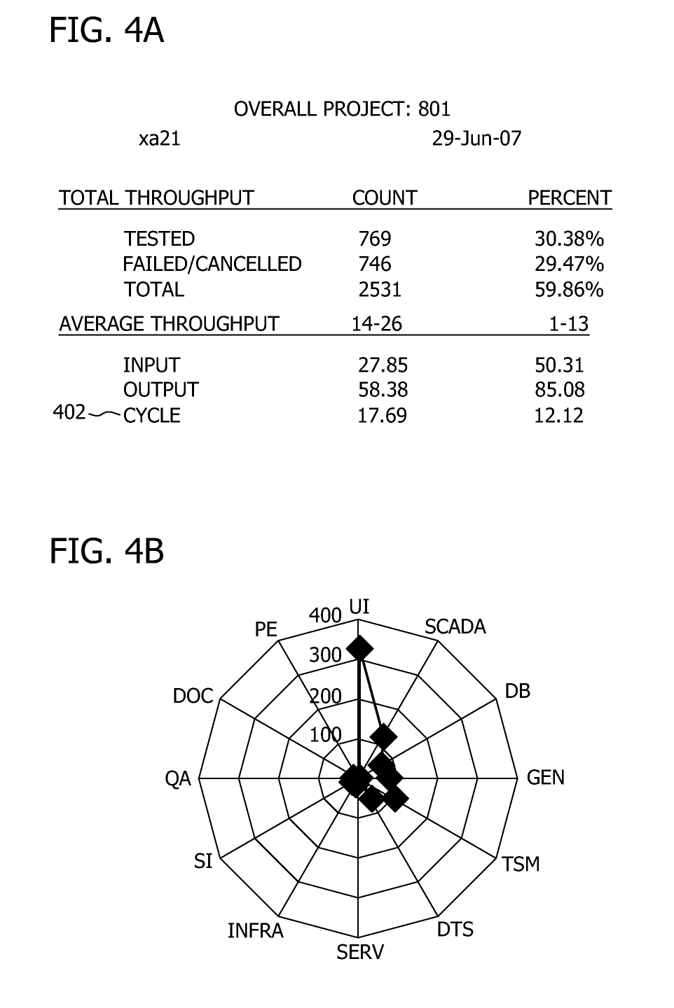

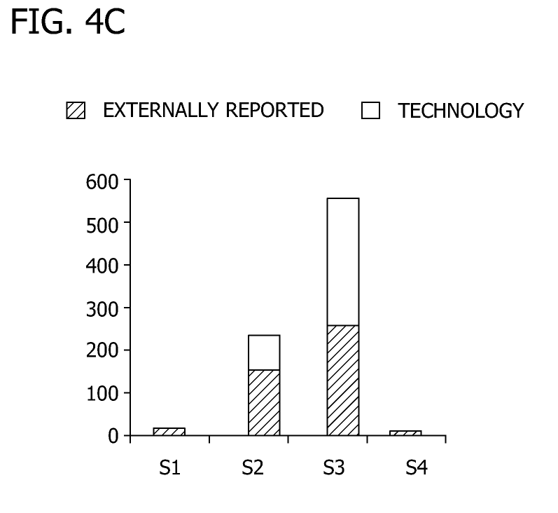

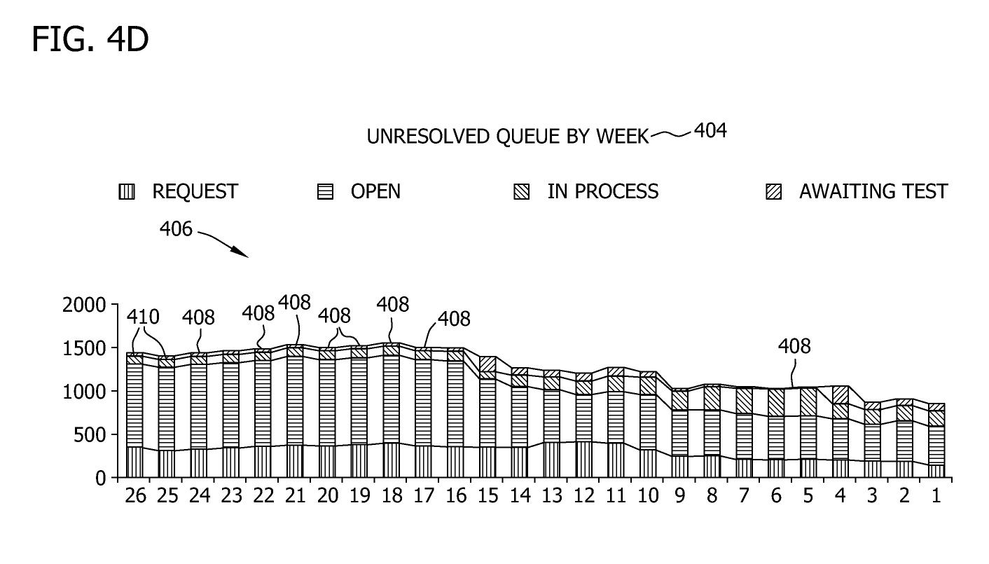

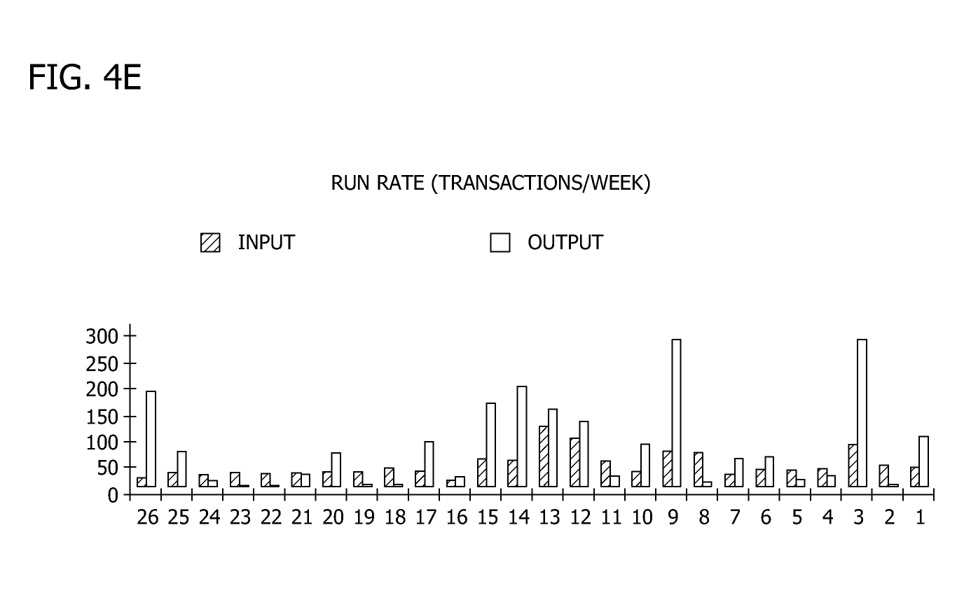

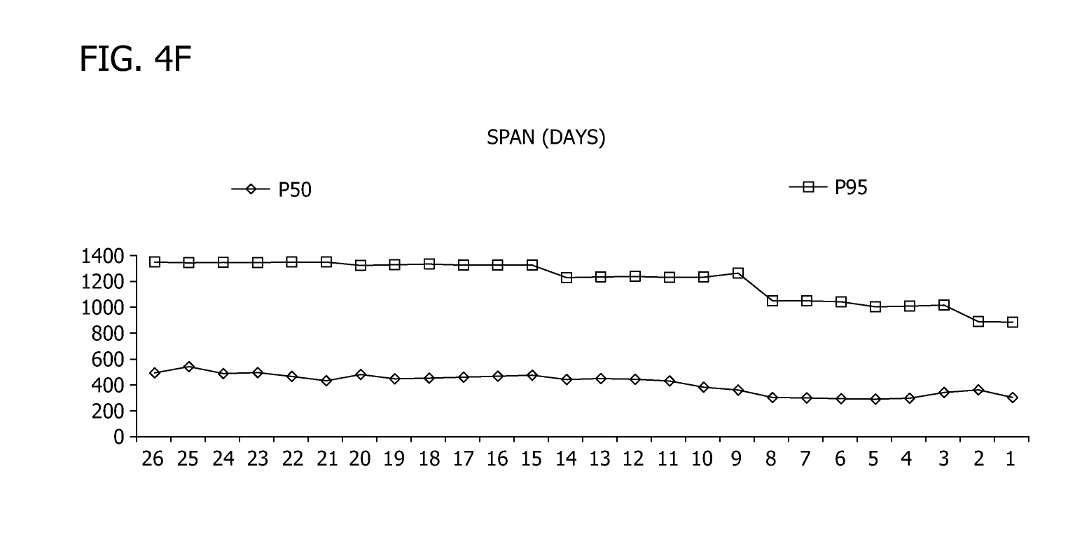

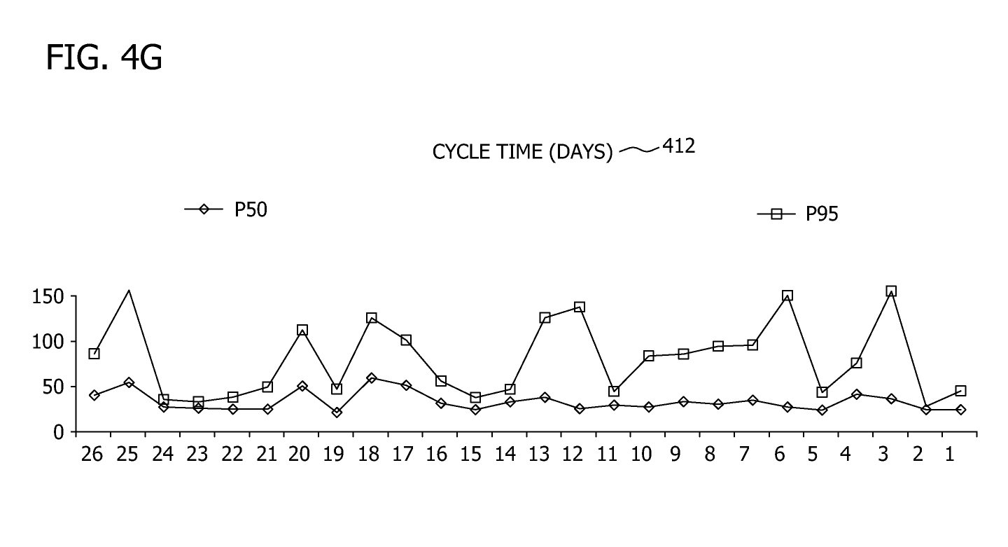

Computing device 102 further includes a user interface module 108 and one or more displays 110 for displaying information to a user, for example, an illustration of a history of a plurality defects in a defect resolution process. User interface module 108 enables an exchange of data between the user and computing device 102. For example, a defect resolution process may include any number of a plurality of phases. Therefore, in order to view a particular phase in the defect resolution process, the user may be provided with a list of phases in the defect resolution process from which the user may select a desired user interface to view. For example, if the user selects to view a “Request” phase, the user may be presented with a user interface as shown in FIG. 3, or if the user selects an “Overall” phase, the user may be presented with a user interface as shown in FIG. 4. User interface module 108 may also allow a user to view multiple phases simultaneously, for example, for comparison purposes. Furthermore, a user may utilize user interface module 108 to request specific information to be displayed regarding a particular phase or phases. For example, a user may indicate specific time periods that information with a selected phase is gathered from, or a user may limit what is shown in a user interface, for example, a user may indicate specific graphs a user requests to be or not be displayed on displays 110. In embodiments, displays 110 may be, for example, a display device, a capacitive touch screen display, a non-capacitive display, a speaker, and a user input selection device that may be separate from and/or communicatively coupled to computing device 102. Displays 110 and user interface module 108 provide presentation capabilities related to, for example, text, images, audio, video, graphics, alerts, and the like.

With reference now to FIG. 2, a flow diagram is provided illustrating a method 200 for creating a user interface for use in displaying a history of a plurality of defects in a defect resolution process that includes a plurality of phases. In the exemplary embodiment of computer software, the plurality of phases may be, for example, a request phase, an open phase, an assign phase, a review phase, an integrate phase, a testable phase, and a passed phase. Each phase represents specific tasks in a defect resolution process. When displaying a history of the plurality of defects, certain information may be needed, for example, information regarding: a current phase location of a defect, how long the defect has been in the current phase, where the defect has been prior to the current phase, and an elapsed period of time the defect has been in the current phase.

With reference back to FIG. 2, initially, information is received indicating which phase in a plurality of phases each of the plurality of defects is currently in at 202. In one embodiment, this information is stored in memory area 104 and can be accessed by the processor 106 when needed. At 204, information regarding an elapsed period of time each of the plurality of defects has been in the current phase is received. In one embodiment, this information is also stored in memory area 104 and can be access the processor 106 when needed.

At 206, information is received regarding a number of defects at a particular priority level that are in the current phase. For example, defects may be assigned a priority level based on a severity of the defect. At 208, information is received regarding a longest length of time one of the defects in the current phase has been in the current phase compared to a shortest length of time one of the defects in the current phase has been in the current phase. At 210, information is received regarding how many defects in the current phase have been rejected back into the current phase in each of the two time periods. At 212, information is received regarding how many defects at a particular priority level, (e.g., severity level) have left the current phase in each of the two time periods.

Next, at 214, a user interface (e.g., as shown in FIGS. 3 and 4) is created utilizing the information obtained from steps 202-212. At 216, the information is presented to a user via a user interface on a display device, for example, displays 110.

A user interface for use in displaying a history of a plurality defects in a defect resolution process is now described with reference to FIGS. 3-3I and 4-4G. As mentioned above, to improve a flow of a defect resolution process, creating a user interface to present a visual representation of a flow of a defect resolution process allows a user to monitor and streamline the process of resolving the defects and therefore reduce a backlog of the defects. The visual representation may be in the form of graphs, such as line graphs, bar graphs, pie charts, color coded graphs, and the like. Each visual representation is an effective tool for visualizing and understanding large quantities of data. A selection of a graph type depends on many factors, including the types of data to be plotted and the kinds of tasks to be performed by end-users. Furthermore, there are hundreds of different graph types, each having a different effect on the types of insight that may be gained from the underlying data. Thus, while the present disclosure is described with respect to exemplary user interfaces as shown in FIGS. 3 and 4, with FIGS. 3A-3I and 4A-4G being magnified portions of FIGS. 3 and 4, respectively, the visual representations illustrated in FIGS. 3 and 4 are merely exemplary in nature and are not intended to limit the scope of the present invention. Further, the exemplary user interface 300 shown in FIG. 3 and the exemplary user interface 400 shown in FIG. 4 represent full views of a “Request” phase and an “Overall” phase, respectively. For example, each of FIGS. 3A-3I may be found in user interface 300, and each of FIGS. 4A-4G may be found in user interface 400. However, as mentioned above, a defect resolution process may include any number of phases. Thus, to view information regarding a particular phase in a defect resolution process, a user may be provided with a list of phases in the defect resolution process from which the user may select a desired user interface to view.

With reference now to FIG. 3A, user interface 300 provides an indication of a current phase at display portion 302. That is, user interface 300 corresponds to defects that are either currently in a “Request” phase or have previously been in the “Request” phase. For example, at display portion 304, it is indicated that 92 defects are in the “Request” phase, and a “Total Throughput,” a “Count,” and a “Percent” are indicated at display portions 306, 308, and 310, respectively. At display portion 312, it is indicated that 921 defects have moved from the “Request” phase to the “Assign” phase, at display portion 314, it is indicated that 291 defects were either canceled or returned to the “Request” phase, and at display portion 316, it is indicated that 1212 defects have entered the “Request” phase.

At display portion 318, as shown in FIG. 3B, user interface 300 provides a user with an indication as to which functional group within the defect resolution process currently has the most defects in queue in the “Request” phase. Thus, as shown in display portion 318, the DTS group has the most defects in queue with about 55 defects.

Further, at display portion 320 an “Average Throughput” is shown. At display portion 322, user interface 300 provides information regarding an average time a defect has been in (“input”) the “Request” phase between two time periods, for example, between weeks “14-26” and between weeks “1-13.” At display portion 324 it is indicated that a weekly average of 36.94 defects have entered the “Request” phase during weeks “14-26,” and at display portion 326 it is indicated that a weekly average of 44.25 defects have entered the “Request” phase during weeks “1-11 13.”

Display portion 328 indicates how many defects have left (“output”) the “Request” phase in each of the two time periods (i.e., weeks “14-26” and weeks “1-13”). For example, as illustrated at display portion 330, a weekly average of 38.29 defects have left the “Request” phase during weeks “14-26,” and as indicated at display portion 332, a weekly average of 60.63 defects have left the “Request” phase during weeks “1-13.”

Display portion 334 illustrates an average cycle (e.g., an average number of days a defect remained within the “Request” phase) for a defect in the “Request” phase in each of the two time periods (i.e., weeks “14-26” and weeks “1-13”). For example, as illustrated at display portion 336, it is indicated that a defect spent an average time of 4.04 days in the “Request” phase during weeks “14-26” and at display portion 338, it is indicated that a defect spent an average time of 6.37 days in the “Request” phase during weeks “1-13.”

At display portion 340, as shown in FIG. 3C, a severity level of the number of defects currently in the “Request” phase is shown. In the current example, user interface 300 provides four different severity levels that a defect can be at: S1=critical, S2=Loss of a major function, S3=Loss of a minor function, and S4=Of little importance. Therefore, of the 92 defects in the “Request” phase, display portion 342 indicates that about 20 defects are at a S2 severity level, display portion 344 indicates that about 68 defects are at a S3 severity level, and display portion 346 indicates that about 4 defects are at a S4 severity level.

At display portion 348, as shown in FIG. 3D, user interface 300 provides a graph regarding “Unresolved Queue by Week.” At display portion 350, user interface 300 provides a range of numbers that represent a number of defects in the “Request” phase (e.g., in queue). The number of defects in the “Request” phase are visually represented by each bar 354 at display portion 352. Each bar 354 is separated with respect to time. For example, at the bottom of display portion 352, each bar 354 has a number (e.g., numbers 1-26) that corresponds to it. That is, bar 356 visually indicates that about 300 defects were in the “Request” phase at week 26. At display portion 358, user interface 300 provides a range of numbers that correspond to each substantially horizontal dotted line 360 and 362, wherein a top dotted line 362 represents a longest length of time a defect has been in the “Request” phase at a particular week, and wherein a bottom dotted line 360 represents a shortest length of time a defect has been in the “Request” phase at a particular week. Again, each number on the bottom of display portion 348 representing a week in a 26 week cycle period, with week 1 being the most current week. Thus, for example, week 1 had about 100 defects in the “Request” phase, with one of the defects in week 1 having been in the “Request” phase for about 800 days, and with one of the defects in week 1 having been in the “Request” phase for about 30 days.

At display portion 362, as shown in FIG. 3E, user interface 300 provides a graph regarding “Run Rate.” At display portion 364, user interface 300 provides a range of numbers that represent a magnitude of defects that came into the “Request” phase during a specific week verses a magnitude of defects that have left the “Request” phase during the specific week. The number of defects entering and leaving the “Request” phase are visually represented by each bar 366 and 368, respectively, at display portion 370. Each bar 366 and 368 is separated with respect to time. For example, at the bottom of display portion 370, each bar 366 and 368 has a number (e.g., numbers 1-26) that corresponds to it. That is, bar 372 visually indicates that about 30 defects have entered the “Request” phase at week 1, and bar 374 visually indicates that about 75 defects have left the “Request” phase during week 1. Thus, in this example, bar 374 indicates that more defects have left the “Request” phase than have entered the “Request” phase during week 1, which indicates that a back log of defects was decreased during week 1. At display portion 376, user interface 300 provides a range of numbers that correspond to a substantially horizontal dotted line 378 that a number of defects that have been rejected during a particular week. Thus, for example, week 1 had about 10 defects in the “Request” phase be rejected back into the “Request” phase.

At display portion 380, as shown in FIG. 3F, user interface 300 provides a graph regarding a “Span.” At display portion 382, user interface 300 provides a range of numbers that represent an amount of time it took for a defect leave the “Request” phase once the defect entered the “Request” phase during a specific week. For example, a top dotted line 384 visually indicates that a defect entered the “Request” phase during week 24 and stayed in the “Request” phase until week 12. A bottom dotted line 386 visually represents an average cycle time a defect has been in the “Request” phase, which coincides with display portion 334.

At display portion 388, as shown in FIG. 3G, user interface 300 provides an area regarding “Relative Priority Number.” At display portion 390, as shown in FIG. 3H, user interface 300 provides a range of numbers that represent a number of defects at a particular severity level that are currently in the “Request” phase. At display portion 392, user interface 300 provides a range of numbers indicating a specific severity level for each defect in the “Request” phase, “NA” indicating a number of defects that have not yet been assigned a severity level. At display portion 394, user interface 300 provides a user with an indication as to which functional group within the defect resolution process currently has the most defects in queue in the “Request” phase that are not assigned a priority level. Thus, as shown in display portion 394, as shown in FIG. 3G, the DTS group has the most defects in queue that are not assigned a priority level with about 55 defects that are not assigned a priority level. At display portion 396, as shown in FIG. 3I, user interface 300 provides a range of numbers indicating an average severity level of defects that have entered the “Request” phase verses the average number of defects that have left the “Request” phase between two time periods, for example, for the past 13 weeks. A top dotted line indicates a number of defects at a high severity level, for example, 51, and a bottom dotted line indicates a number of defects a lower severity level, for example, S2. Thus, for example, week 1 had more defects at a low severity level leave the “Request” phase than defects at higher severity level. This may indicate that programmers are “picking and choosing” which defect they resolve, lower severity level defects being easier to resolve.

As mentioned above, an exemplary defect resolution may have a plurality of phases, for example, a request phase, an open phase, an assign phase, a review phase, an integrate phase, a testable phase, and a passed phase. FIG. 3 and FIGS. 3A-3I represent an exemplary user interface 300 for a “Request” phase. However, one of ordinary skill in the art guided by the teaching herein will appreciate that each phase in a resolution process may be visually represented by a similar user interface including information unique to each phase.

With Reference now to FIG. 4, user interface 400 provides overall information from each phase in a defect resolution process, for example, overall information from a request phase, an open phase, an assign phase, a review phase, an integrate phase, a testable phase, and a passed phase. Thus, although interface 400 is similar to interface 300 shown in FIG. 3, numbers shown in interface 400 represent all defects currently in the process no matter what phase they are currently in. For example, at display portion 402, as shown in FIG. 4A, user interface 400 provides information regarding cycle times. As shown at display portion 402, an average cycle time for a defect in weeks 14-26 was 17.69 days, and an average cycle time within the past 13 weeks is 12.12 days, which indicates that cycle times are improving. One of the visual differences between user interface 300 and user interface 400 is that at display portion 404, as shown in FIG. 4C, user interface 400 provides a graph regarding “Unresolved Queue by Week,” but at display portion 406, as shown in FIG. 4D, the number of defects in each of the phases at a particular week are visually represented by each bar 408. For example, bar 410 visually indicates that at week 26, about 300 defects are in the “Request” phase, about 1300 defects are in an “Open” state, about 1400 defects are in process and about 1450 defects are awaiting testing. FIG. 4E provides information regarding a run rate per week throughout the process, and FIG. 4F provides a range of numbers that represent an amount of time it took for a defect to leave a phase once the defect entered a phase during a specific week. Further, as shown in FIG. 4G, at display portion 412, user interface 400 provides information regarding an average cycle time for each defect throughout the entire process. For example, an amount of time it took for defect to leave a “Test” phase from the time the defect entered the “Request” phase.

### Exemplary Operating Environment

A computer or computing device such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

The computer may operate in a networked environment using logical connections to one or more remote computers, such as a remote computer. Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

The embodiments illustrated and described herein as well as embodiments not specifically described herein but within the scope of aspects of the invention constitute exemplary means for determining portions of a route during which the computing device 102 is expected to have limited access to a wireless network, and exemplary means for obtaining and caching content associated with portions of a route during which the computing device 102 is expected to have limited access to the wireless network.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Having described aspects of the invention in detail, it is apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A user interface embodied on one or more storage media having computer executable instructions for instructing a processor to display a history of a plurality of defects in a defect resolution process that includes a plurality of phases, the user interface comprising:
a display portion for illustrating a current phase of a defect from the plurality of phases; and
a display portion for illustrating an amount of elapsed time that the defect has been in the current phase.

2. A user interface in accordance with claim 1, further comprising a display portion for displaying a priority level of the defect.

3. A user interface in accordance with claim 1, further comprising a display portion for displaying a history log indicating which phase(s) of the plurality phases the defect has been through prior to the current phase.

4. A user interface in accordance with claim 3, further comprising a display portion for displaying an elapsed time period that the defect was in each prior phase.

5. A user interface in accordance with claim 1, further comprising a display portion for displaying an average time each defect is in the current phase.

6. A user interface in accordance with claim 1, further comprising a display portion for displaying an elapsed period of time that each defect has been in the current phase.

7. A user interface in accordance with claim 1, further comprising a display portion for displaying a number of defects that have entered the current phase between two time periods.

8. A user interface in accordance with claim 1, further comprising a display portion for displaying a number of defects that have left the current phase between two time periods.

9. A user interface in accordance with claim 1, further comprising a display portion for displaying an average cycle for a defect in the current phase between two time periods.

10. A user interface in accordance with claim 1, further comprising a display portion for displaying a number of defects at a particular priority level that are in the current phase.

11. A user interface in accordance with claim 1, further comprising a display portion for displaying a number of defects that are in the current phase.

12. A user interface in accordance with claim 1, further comprising a display portion for displaying a number of defects that have been through the current phase.

13. A user interface in accordance with claim 1, further comprising a display portion for displaying a longest length of time a defect in the current phase has been in the current phase and a shortest length of time a defect in the current phase has been in the current phase.

14. A user interface in accordance with claim 1, further comprising a display portion for displaying an average of a number of defects that have entered the current phase between two time periods and an average of a number of defects that have left the current phase in each of the two time periods.

15. A user interface in accordance with claim 1, further comprising a display portion for displaying a number of defects in the current phase that have been rejected back into the current phase between two time periods.

16. A user interface in accordance with claim 1, further comprising a display portion for displaying a number of defects at a particular severity level that have left the current phase between two time periods.

17. A method for creating a user interface for use in displaying a history of a plurality of defects in a defect resolution process including a plurality of phases, the method comprising:
receiving information indicating a phase in the plurality of phases each of the defects is currently in;
receiving information indicating an elapsed period of time each of the plurality of defects has been in the current phase;
creating a user interface comprising the received information; and
presenting the user interface on a display device.

18. A method in accordance with claim 17, further comprising receiving information indicating:
a priority level of each of the defects;
which phase(s) of the plurality phases each of the defects has been through prior to the current phase;
how long each of the defects was in the prior phase(s);
an average time a defect has been in the current phase between two time periods;
how many defects have entered the current phase in each of the two time periods;
how many defects have left the current phase in each of the two time periods;
an average cycle for a defect in the current phase in each of the two time periods;
how many defects at a particular priority level are in the current phase;
how many defects are in the current phase;
a longest length of time one of the defects in the current phase has been in the current phase compared to a shortest length of time one of the defects in the current phase has been in the current phase;
how many defects in the current phase have been rejected back into the current phase in each of the two time periods; and
how many defects at a particular severity level have left the current phase in each of the two time periods.

19. A system for creating a user interface for use in displaying a history of a plurality defects in a defect resolution process including a plurality of phases, the system comprising:
a display device; and
a computing device comprising:
a memory area; and
a processor programmed to:
access information stored in the memory area indicating which phase in the plurality of phases each of the plurality of defects is currently in;
access information stored in the memory area indicating an elapsed period of time each of the plurality of defects has been in the current phase;
create a user interface comprising the accessed information; and
present the user interface on the display device.

20. A system in accordance with claim 19, wherein the processor is further programmed to access information indicating:
a priority level of each of the defects;
which phase(s) of the plurality phases each of the defects has been through prior to the current phase;
how long each of the defects has been in the prior phase(s);
an average time a defect has been in the current phase between two time periods;
an average cycle for a defect in the current phase in each of the two time periods;
how many defects at a particular priority level are in the current phase;
how many defects have been in the current phase in each of the two time periods;
a longest length of time one of the defects in the current phase has been in the current phase compared to a shortest length of time one of the defects in the current phase has been in the current phase;
how many defects have entered the current phase in each of the two time periods compared to how many defects have left the current phase in each of the two time periods;
how many defects in the current phase have been rejected back into the current phase in each of the two time periods; and
how many defects at a particular severity level have left the current phase in each of the two time periods.
